(19) United States
(12) Patent Application Publication
(10) Pub. No.: US 2014/0373024 A1
(43) Pub. Date: Dec. 18, 2014

(54) REAL TIME PROCESSOR

(71) Applicant: NVIDIA Corporation, Santa Clara, CA (US)

(72) Inventors: Tom Watts, Bristol (GB); Pete Cummings, Bristol (GB); Mark Van Nostrand, Austin, TX (US)

(73) Assignee: NVIDIA Corporation, Santa Clara, CA (US)

(21) Appl. No.: 13/918,049

(22) Filed: Jun. 14, 2013

(51) Int. Cl. G06F 9/50

(52) U.S. Cl. CPC G06F 9/5011; G06F 9/5016
USPC 718/104

(57) ABSTRACT

One aspect of the disclosure provides an embodiment of a method of processing data in a processor in a shared resource computer system, where a processing module shares at least one resource with at least one other processing module. The method, implemented by a processor, comprises receiving a resource allocation for executing code and monitoring a resource related condition of the processor in the execution of the code at a current resource level. The method further comprises recognizing a resource constraint when the resource allocation is insufficient to meet real time constraints for executing the code at the current resource level and modifying operation of the processor responsive to recognizing the resource constraint to execute the code to meet the real time constraints at a cost of increased power consumption or reduced quality of output.

### TECHNICAL FIELD

This disclosure relates to real time processing, and particularly to the delivery of real time processing in a constrained environment.

### BACKGROUND

Such a constrained environment can arise where a real time processor shares resources with another processor. An example of the scenario is in a wireless computing system, such as a mobile terminal, where a modem processor performing real time processing shares resources with a host or application processor.

A resource controller, for example within the host processor, determines an allocation of resource to the modem processor based on a request from the modem. To ensure that the modem processor can always meet real time constraints and still deliver adequate performance, resource allocation is heavily margined. That is, the allocation covers worst case scenarios with the consequence that very often a resource is managed in a manner which over supplies a current need. For example a memory controller is instructed to run faster to allow for an extra modem load which might or might not materialize. This is wasteful of resource and potentially of power where unused resources could be partially powered down or run at a reduced frequency, and therefore reduce power consumption. Moreover, it can have the effect that a user interface and other processing units of the wireless terminal can experience reduced functionality unnecessarily because a resource is reserved for the modem processor even if the modem processor does not actually need it. That is, the wireless terminal offers reduced functionality, for example, the user interface may run/update more slowly than is necessary.

### SUMMARY

One aspect provides a method of processing data in a processor. One embodiment of the method provides a method of processing data in a shared resource computer system where a first processing module shares at least one resource with at least one other processing module. The method, implemented by the processor, comprises receiving a resource allocation for executing code at a current resource level and monitoring a resource related condition, such as the performance of the processor, in execution of the code at the current resource level. An alternative resource related condition is notification that there is an urgent change in required computation of resources. The method further comprises recognizing a resource constraint while executing the code to meet real time constraints. The method further comprises responsive to recognizing the resource constraint modifying operation of the processor to execute the code to meet real time constraints at a cost of increased power consumption or reduced quality of output. The method can comprise issuing a request for an increased resource allocation for further execution of the code.

Another aspect provides a modem processor. In one embodiment, the modem processor is a modem processor configured to operate in a shared resource computer system and is configured to execute computer instructions to carry out the following steps. A resource allocation for executing code is received. A resource related condition is monitored, for example, the performance of the processor in the execution of the code at a current resource level. A resource constraint is recognized, for example, by using at least one performance parameter to dynamically determine when the resource allocation is insufficient to meet real time constraints for executing the code at the current resource level. Operation of the processor is modified to execute the code to meet the real time constraints at a cost of increased power consumption or reduced quality of output. A request can be issued for an increased resource allocation for further execution of the code.

In yet another aspect there is provided a wireless terminal. In one embodiment the wireless terminal comprises a modem processor, a host processor, and a computer resource. The host processor is in communication with the modem processor. The computer resource is accessible by the modem processor and the host processor and shared between them. The modem processor is configured to execute computer instructions to carry out the following steps. A resource allocation is received from the host processor for executing code. The performance of the processor in the execution of the code is monitored and at least one performance parameter is generated. The at least one performance parameter is used to dynamically determine when an increased resource allocation is required to meet real time constraints for executing the code. Operation of the processor is modified to execute the code to meet the real time constraints at a cost of increased power consumption or reduced quality of output. A request is issued for an increased resource allocation for further execution of the code.

### BRIEF DESCRIPTION OF THE DRAWINGS

Reference is now made to the following descriptions taken in conjunction with the accompanying drawings, in which:

FIG. 1 is a schematic diagram of a computing environment in a wireless terminal;

FIG. 2 is a functional diagram of a performance monitoring tool;

FIG. 3 is a flow chart illustrating operation to allocate resource; and

FIG. 4 is a schematic block diagram illustrating the selection of functions for reducing workload.

### DETAILED DESCRIPTION

In the present disclosure, the modem requests the resource that it currently needs, assuming the host processor is idle, and then dynamically reacts to the actual performance that the modem processor is delivering, based on the resource granted by the host. One factor which can increase a requirement for resource is the radio access technology (RAT). There is a significant difference between a modem operating in 2G and in 4G for example. For that reason, when a modem changes the RAT, it issues a request for a greater resource allocation. As mentioned above however, previously it has been necessary to margin the resource allocation to accommodate any possible peaks in modem and competing traffic. If not margined properly, those peaks will cause the modem processor to crash in the new RAT. The techniques described in the following disclosure allow the modem processor to react faster to a situation of constrained resource than it is possible to change the allocation of the resource, or when there is simply insufficient resource available.

In order to meet real time constraints, the modem processor is required to issue instructions at a certain rate. This rate can be degraded if, for example, memory latency is poor, or new code has been fetched by the modem processor. Such new code can increase the cache miss rate and slow down branch prediction. This phenomenon can particularly affect soft modems, where each function to be implemented by the modem is fetched from the memory as a code sequence to be executed by the processor.

The modem monitors a resource related condition which can be either performance or a notification that an increased resource allocation is needed (for example, to a change in workload such as a RAT change).

When the modem processor recognizes that the current allocation of a resource (e.g. memory bandwidth) is insufficient in the context of the current allocation of other resources, e.g. clock speed, for the current workload to meet real time constraints, it modifies operation of the processor by accelerating the clock or decreasing the work performed by the processor. The first of these has the effect of increasing power consumption, and the second has the effect of reducing the quality of output from the function whose workload has been decreased. Nevertheless, these effects are temporary, because when the performance increases, either because the resource allocation which has been requested is granted, or because the demand has dropped off, the clock is returned to a more optimal value, and the work load can be increased by selecting a function with an improved quality of output.

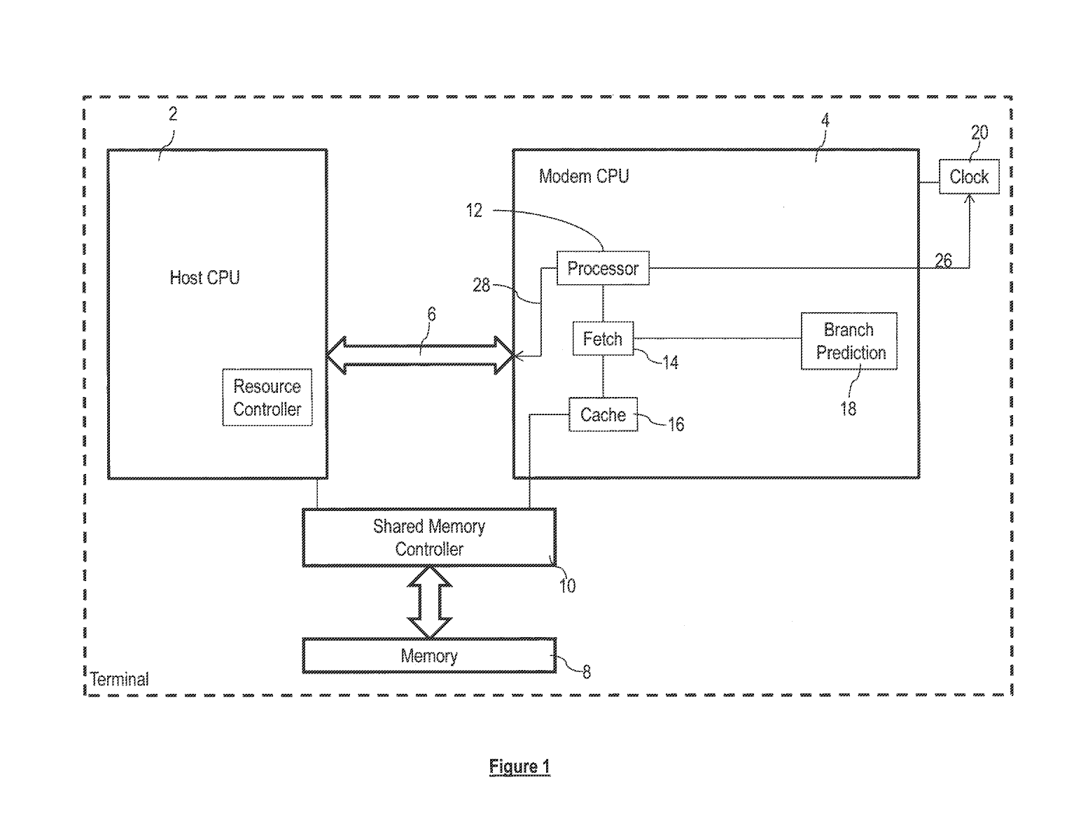

FIG. 1 is a schematic diagram of a computing environment where a host central processing unit (CPU) 2 shares a memory resource with a modem CPU 4. The host CPU 2 executes a resource controller which manages the resources of the computing environment and in particular allocates resource for use by the modem CPU 2. The computing environment can be for example a wireless terminal where the modem processor processes incoming samples r(k) received from a wireless network.

A shared resource in the form of a dual ported memory controller 10 that supports multiple clients connects the host CPU 2 and the modem CPU 4 to a shared memory 8.

The modem CPU requests a resource allocation. A resource allocation (which may be as requested or less than requested) is transmitted from the first CPU 2 to the modem CPU over an interface 6. Alternatively, the host CPU and the modem CPU can communicate via the shared memory 8.

Once the modem CPU receives a resource allocation it must operate within that. Similarly, the host CPU 2 cannot utilize it. It is reserved for the use of the modem CPU 4. The modem CPU comprises a processor 12 configured to execute code (instructions) which can be fetched from a local memory (not shown) or from the shared memory 8. The code provides functions to be implemented by the modem, including signal processing functions. A fetch unit 14 can operate to fetch instructions, via a cache 16. A branch prediction unit 18 facilitates the fetch operation by predicting expected branches which cause the fetch operation to commence fetching from a new memory location. The modem CPU is operated under the control of a clock 20 which governs the speed of the processor—number of operational cycles per second, often measured as MIPs.

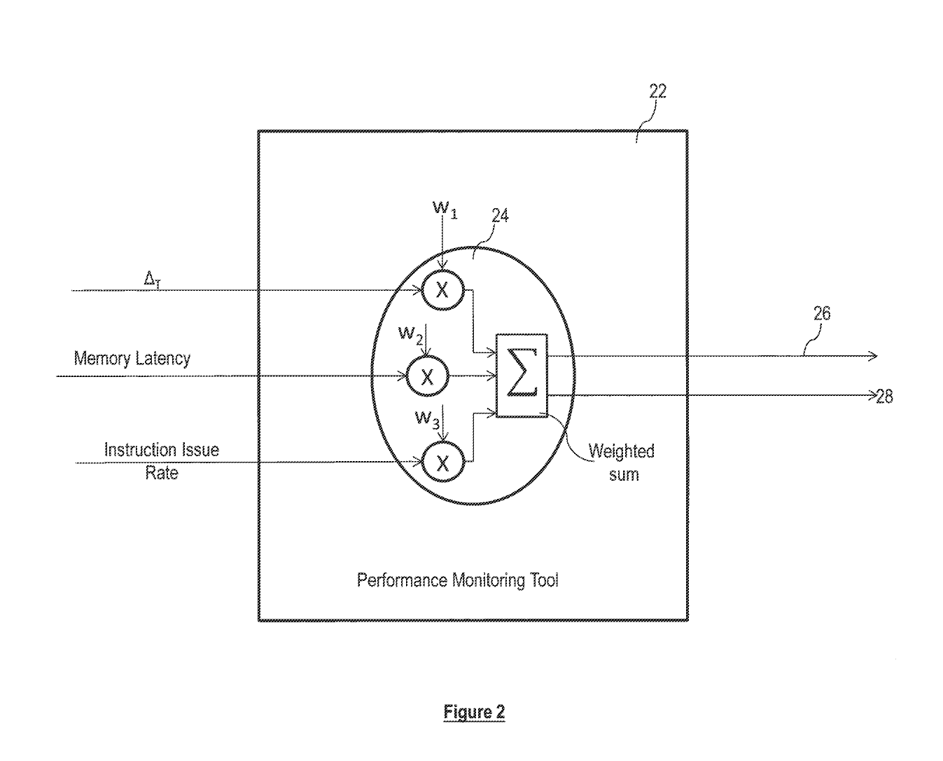

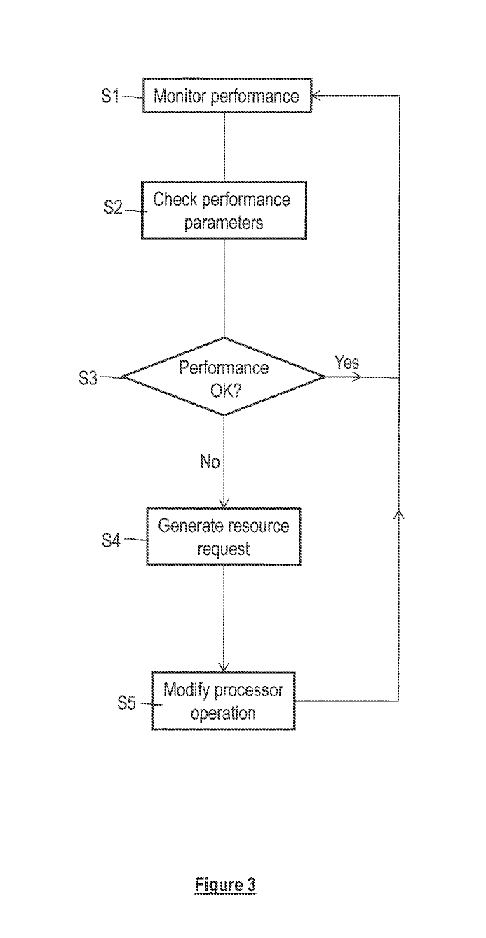

A performance monitoring module is provided. This can be in the form of a hardware or firmware device. Alternatively, the modem CPU 4 can execute a performance monitoring tool 22 (FIG. 2) which monitors the performance of the CPU 4. The tool can be a sequence of instructions fetched from the memory 8. See step S1 in FIG. 3. For example, the tool 22 can monitor the issue rate of instructions from the fetch unit 14 to the processor 12 and/or the memory latency experienced by the modem CPU 4 when executing a memory access. As a further alternative, it can compare the expected amount of time to execute a function with the actual amount of time taken and generate a difference ΔT. The issue rate, memory latency and difference ΔT are termed herein as “performance parameters”.

Any of the performance parameters can be used (step S2) to determine a clock control signal 26 which controls the clock speed. Alternatively, a weighted sum 24 of the foregoing parameters can be used to determine the clock control signal.

When the performance monitoring tool detects a reduction in performance (step S3), it signals via signal 26 to temporarily increase the clock speed of clock 20 (step S5). The reduction in performance can be due to a constrained resource allocation, or a quality of service for incoming signals being less good than expected, or the modem actually doing more than it had budgeted to do. Methods of controlling clock speed are known in the art and are not discussed further herein. For example, existing active power management systems control supply voltage and/or clock frequency for power consumption reasons. In addition, the modem processor 12 may signal (step S4) to the host CPU 2 via a resource request 28 that more resource is required. The modem processor can determine whether or not to signal for more resource in various ways. For example, it may depend on whether the current constrained resource is due to a spike in the modem load or is in fact steady state. That is, it might be sufficient to temporarily increase the clock speed to manage the peak without actually requesting more resource. If possible, the host grants the request by allocating more resource to the modem CPU. The performance monitoring tool notices the performance improve or responds to notification of increased resource allocation and controls the clock speed to reduce it to a nominated (e.g. more optimal) level.

In this way, the real time constraint has continued to be met, possibly while an increased resource allocation is simultaneously requested, and provided. There may be a power cost to this, but it is expected that in most cases the cost is small or the increased clock speed is only temporary.

In general terms, the clock control signal 26 can be considered as an operation modification signal for modifying operation of the processor to ensure that it meets real time constraints in the execution of its code, even when faced with constrained resource. As an alternative to a cost of increase power consumption, a different cost can be considered in terms of reduced quality of output of the code that is being executed. The code can comprise different functions which the modem is required to implement, including signal processing functions. The quality of output of a signal processing function is determined by the quality of the data which is output as a result of the processing of incoming signals, received from a wireless environment. The quality of the output of the function can be affected by the nature of the function which is used to process the incoming signal data, or the implementation of that function. It is also affected by channel conditions in the wireless environment.

The processor 12 is responsible for processing incoming samples r(k) received over a wireless interface. The processor 12 can execute a number of different functions which are held in an instruction memory (for example, in the shared memory 8) in the form of code sequences. This provides a so-called soft modem which has a number of advantages discussed further herein.

The modem is expected to deliver a certain quality of output when executing these functions, particularly signal processing functions, and is governed by real time constraints as well as an uncertain external wireless environment which can affect the quality of signal data supplied for processing. Moreover, the demand on the processing requirement of the modem is uncertain, depending on user activity as well as on the external environment. These changes in demand can be rapid and significant.

In the present disclosure, selection of a function/parameter is made by fetching different code sequences to be executed by the processor 12.

In such a software implementation of the receiver, a common platform can be reused to adaptively select the optimum set of signal processing functions capable of maximizing performance and minimize power consumption. There is the added advantage in the present invention that a “soft modem” permits the dynamic adaptation of operation of the processor to reduced resource, while still meeting real time constraints.

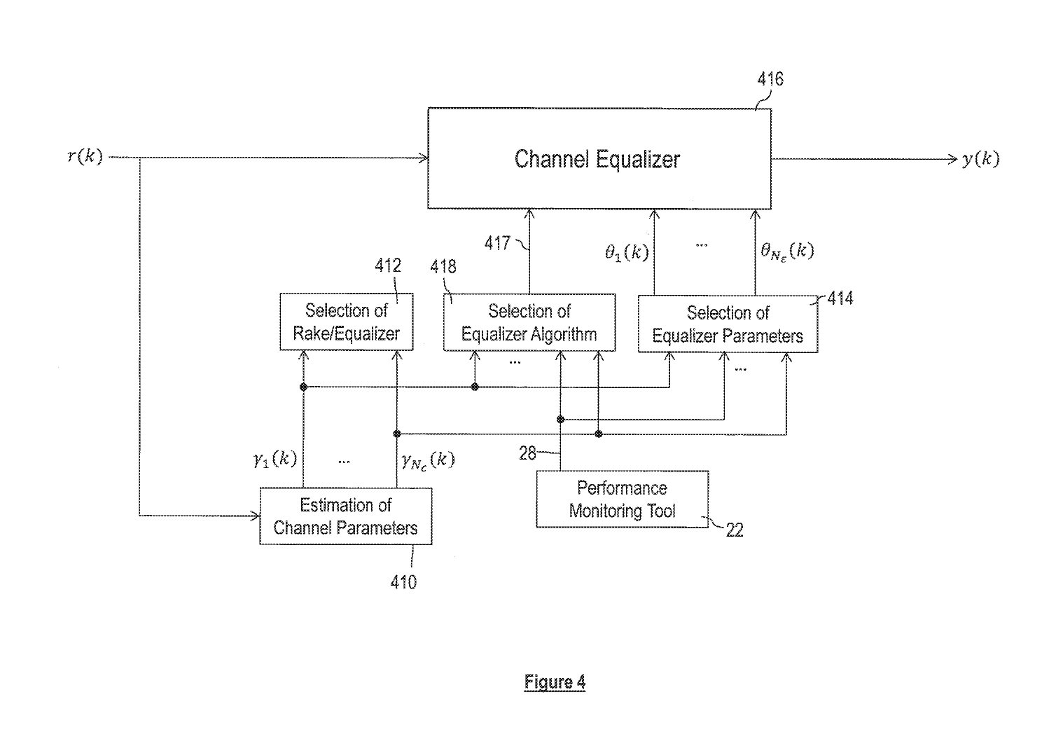

FIG. 4 is a schematic block diagram which illustrates functions that are executed by the processor 12. A first function denoted by block 410 is referred to as estimation of channel parameters. This function estimates a number of different parameters related to the communication channels over which the radio signals are transmitted in the wireless communication system. The function 410 provides at time k the outputs γₙ(k), n=1, . . . , N_{C}, where N_{C} denotes the number of estimated channel parameters, that represent a set of channel parameters derived from the received signal samples r(k). The estimated channel parameters γₙ(k) can be used for a number of different purposes. As illustrated in FIG. 4, they are supplied to a Selection of Rake/Equalizer Receiver function 412 which determines whether to process the received samples using a rake receiver or an equalizer receiver. The rake receiver or equalizer receiver is implemented by the processor 12 executing the appropriate code sequence from the instruction memory 8.

The parameters γₙ(k) are further supplied to a Selection of Equalizer Algorithm function 418 which is used in the event that an equalizer receiver 418 is selected. In addition, the function 418 receives the signal 28 from the performance monitoring tool. If used, the function 418 selects a particular algorithm for implementing the equalizer receiver 416 based on the signal 28, optionally taking into account the channel parameters. The selected algorithm is supplied to the channel equalizer as denoted diagrammatically by input 417. In practice of course this will be implemented by the appropriate algorithm being selected as a code sequence from the instruction memory.

The channel parameters γₙ(k) and signal 28 are also supplied to a Selection of Equalizer Parameters function 14. The equalizer parameter selection function 414 is used in the event that an equalizer receiver is selected (as denoted by block 416) and controls parameters used for implementing the equalizer receiver, these parameters being denoted θₙ(k), n=1, . . . , N_{E} where N_{E} denotes the number of relevant equalizer parameters.

The choice of equalizer or equalizer parameters is governed by the amount of resource available. When a performance decrease is detected, an alternative is chosen which delivers an output more quickly albeit of reduced quality.

The equalizer algorithm can be selected from between: a linear and a non-linear structure; selecting between a Baud-spaced and a fractionally-spaced structure; and selecting one of a plurality of different equalizer cost functions.

The following are examples of equalizer parameters which affect the workload of the processor and the quality of the processed output.

Selection of Channel Estimation Window

Selection of Channel Estimation Filter

Selection of Channel Estimation Update Frequency

Selection of Channel Estimation Threshold

Selection of Noise Estimation Filter

Selection of Number of Equalizer Coefficients

Selection of Number of FF/FB Equalizer Coefficients

Selection of Equalizer Coefficients Update Frequency/Step-Size

Selection of Equalizer Delay Parameter

A further example of a function whose behavior can be modified to alter the amount of resource required in relation to the quality of output that is delivered is an iterative turbo decoder. In an iterative turbo decoder, signal samples are decoded in multiple iterations. The more iterations, generally the better quality of output. Such a turbo decoder can be modified to reduce the number of iterations that it utilizes in response to the signal indicating that there is a constrained condition-prevailing.

In the present description, a single modem processor is discussed. However, in one embodiment, the modem includes a plurality of processors. In that connection, if one of the processors recognizes an insufficient resource allocation (through a drop in performance or notification of increased allocation requirement), it can alter its priority in arbitration for the shared resource compared to the other modem processors.

In the description herein the shared resource is a memory controller. It will be appreciated however that the techniques of the present disclosure operate for any resourced shared amongst processing modules which can be individual functions or processors. For example, the shared resource could be a first in first out buffer or current from a shared battery.

The techniques of the present disclosure have been discussed in relation to the context where a host processor and a modem processor share a resource. The techniques described above for altering the resource requirements of functions executed on a processor can also be used to manage peaks of resource requirement in the context of multiple applications operating on a single processor. Thus, the disclosure extends to a context wherein data is processed in a processor with a first processing module sharing at least one resource with another processing module, wherein each processing module is a software function.

References herein to code include instructions executed by the processor as embodied on a non-transitory computer readable medium.

Those skilled in the art to which this application relates will appreciate that other and further additions, deletions, substitutions and modifications may be made to the described embodiments.

What is claimed is:

1. A method of processing data in a processor in a shared resource computer system, wherein a processing module shares at least one resource with at least one other processing module, the method comprising, implemented by the processor:
receiving a resource allocation for executing code;
monitoring a resource related condition of the processor in the execution of the code at a current resource level;
recognizing a resource constraint when the resource allocation is insufficient to meet real time constraints for executing the code at the current resource level; and
modifying operation of the processor responsive to recognizing the resource constraint to execute the code to meet the real time constraints at a cost of increased power consumption or reduced quality of output.

2. A method according to claim 1, wherein the step of recognizing comprises monitoring the performance of the processor and using at least one performance parameter to dynamically determine when the increased resource allocation is required.

3. A method according to claim 2, wherein the first processing module comprises a modem processor and at least one other processing module is a host processor configured to provide resource allocation to the modem processor.

4. A method according to claim 1, wherein when the increased resource allocation is received, the operation of the processor is modified to reduce the power consumption or increase the quality of output to a nominated level.

5. A method according to claim 1, wherein the step of modifying operation of the processor comprises increasing the speed of a clock signal which controls operation of the processor.

6. A method according to claim 1, wherein the step of modifying operation of the processor comprises selecting one of different code sets to implement a signal processing function, wherein the different code sets for implementing the function have differing qualities of output.

7. A method according to claim 1, wherein the step of modifying operation of the processor comprises modifying the implementation of a function implemented by the code to reduce the quality of output of that function.

8. A method according to claim 7, wherein the step of modifying the implementation of a function comprises, where the function is an equalizer function, selecting from a set of equalizer parameters values for at least one of the equalizer parameters affecting the quality of output of the equalizer function.

9. A method according to claim 1, wherein the performance parameter is selected from:
instruction issue rate of the processor;
memory latency; and
a comparison between an expected time to implement a function and the actual time to implement the function.

10. A method according to claim 1, wherein multiple performance parameters are combined in a weighted sum to generate an operation modification signal for modifying operation of the processor.

11. A method according to claim 1, wherein the shared resource is memory.

12. A method according to claim 1, wherein each processing module is a software module comprising a function executed on the processor.

13. A method according to claim 3, wherein the step of recognizing comprises receiving a notification that the modem processor requires more resource in a timescale too small to be immediately satisfied by an increased resource allocation.

14. A method according to claim 1, the method further comprising issuing a request for an increased resource allocation for further execution of the code.

15. A modem processor configured to operate in a shared resource computer system, the modem processor configured to execute computer instructions to carry out the following steps of:
receiving a resource allocation for executing code;
monitoring a resource related condition of the processor in the execution of the code at a current level of resource;
recognizing a resource constraint when the resource allocation is insufficient to meet real time constraints for executing the code at the current level of resource, and
(i) modifying operation of the processor to execute the code to meet the real time constraints at a cost of increased power consumption or reduced quality of output,

16. A wireless terminal comprising:
a modem processor;
a host processor in communication with the modem processor;
a computer resource accessible by the modem processor and the host processor and shared between them, wherein the modem processor is configured to execute computer instructions to carry out the following steps of:
receiving from the host processor a resource allocation for executing code;
monitoring the performance of the processor in the execution of the code and generating at least one performance parameter;
using the at least one performance parameter to dynamically determine when an increased resource allocation is required to meet real time constraints for executing the code, and
(i) modifying operation of the processor to execute the code to meet the real time constraints at a cost of increased power consumption or reduced quality of output

17. A wireless terminal according to claim 16, wherein the modem processor is configured to issue a request for an increased resource allocation for further execution of the code when an increased resource allocation is required and to modify operation of the process until the resource allocation is met.

18. A wireless terminal according to claim 16, comprising a user interface under the control of the host processor.

19. A wireless terminal according to claim 16, wherein the computer resource is a memory.

20. A wireless terminal according to claim 15, wherein the request for increased resource allocation is conveyed from the modem processor to the host processor via a shared memory.
